(19) United States
(12) Patent Application Publication
(10) Pub. No.: US 2014/0152745 A1
(43) Pub. Date: Jun. 5, 2014

(54) IMAGE FORMING APPARATUS

(71) Applicant: Soyoung Park, Kanagawa (JP)

(72) Inventor: Soyoung Park, Kanagawa (JP)

(73) Assignee: RICOH COMPANY, LTD., Tokyo (JP)

(21) Appl. No.: 14/089,027

(22) Filed: Nov. 25, 2013

(30) Foreign Application Priority Data
Dec. 4, 2012 (JP) 2012-265065

(51) Int. Cl. B41J 2/175

(52) U.S. Cl. CPC B41J 2/175
USPC 347/86

(57) ABSTRACT

An image forming apparatus includes a recording head, a carriage, and a cartridge unit. The recording head has nozzles to eject droplets of liquid. The carriage is reciprocally movable and mounting a recording head. The cartridge unit replaceably mounts a liquid cartridge to store the liquid to be supplied to the recording head. The cartridge unit is movable between a supply position at which the cartridge unit does not interfere with a movement range of the carriage and a replacement position at which the cartridge unit interferes with the movement range of the carriage. When the carriage is moved, the cartridge unit is moved to the supply position. When the liquid cartridge is replaced, the cartridge unit is moved to the replacement position.

### CROSS-REFERENCE TO RELATED APPLICATIONS

This patent application is based on and claims priority pursuant to 35 U.S.C. §119 to Japanese Patent Application Nos. 2012-265065, filed on Dec. 4, 2012 in the Japan Patent Office, the entire disclosure of which is hereby incorporated by reference herein.

### BACKGROUND

1. Technical Field

This disclosure relates to an image forming apparatus.

2. Description of the Related Art

This disclosure relates to an image forming apparatus and more spec ally to an image forming apparatus including a recording head to eject liquid droplets.

Image forming apparatuses are used as printers, facsimile machines, copiers, plotters, or multifunction devices having two or more of the foregoing capabilities. As one type of image forming apparatuses employing a liquid-ejection recording method, for example, inkjet recording apparatuses are known that use a recording head for ejecting droplets of liquid (e.g., ink).

As a liquid supply method in such an image forming apparatus, an off-carriage method is known in which a replaceable liquid cartridge is disposed at an apparatus body side to supply liquid toward a recording head via a supply tube.

A supply unit to replaceably mount a liquid cartridge is typically disposed at a position outside a recording region and at which the supply unit does not interfere with a movement range of a carriage mounting the recording head.

JP-2004-345246 proposes an inkjet recording apparatus that includes a casing above a recording unit. The casing has an opening at the front face side and a cover to openably cover the opening. The casing includes a cartridge holder set at the front side so that the cartridge holder is slidable in a front and back direction. When a jammed sheet is removed, the cartridge holder is moved to a rear-side retracted position.

However, for the above-described configuration in which the supply unit is disposed at a lateral side of the recording region, an apparatus body is likely to have a relatively large side in the width direction. Additionally, as described in JP-2004-345246, for the configuration in which the cartridge holder (supply unit) is disposed above the recording region, the apparatus body is likely to have a relatively large size in the height direction.

### BRIEF SUMMARY

In at least one exemplary embodiment of this disclosure, there is provided an image forming apparatus including a recording head, a carriage, and a cartridge unit. The recording head has nozzles to eject droplets of liquid. The carriage is reciprocally movable and mounting a recording head. The cartridge unit replaceably mounts a liquid cartridge to store the liquid to be supplied to the recording head. The cartridge unit is movable between a supply position at which the cartridge unit does not interfere with a movement range of the carriage and a replacement position at which the cartridge unit interferes with the movement range of the carriage. When the carriage is moved, the cartridge unit is moved to the supply position. When the liquid cartridge is replaced, the cartridge unit is moved to the replacement position.

### BRIEF DESCRIPTION OF THE DRAWINGS

The aforementioned and other aspects, features, and advantages of the present disclosure would be better understood by reference to the following detailed description when considered in connection with the accompanying drawings, wherein:

FIG. 1 is a side view of a mechanical section of an image forming apparatus according to some exemplary embodiments of this disclosure;

FIG. 2 is a side view of the image forming apparatus of FIG. 1 in a state in which a front cover is open;

FIG. 3 is a plan view of the image forming apparatus of FIG. 1;

FIG. 4 is a back view of the image forming apparatus of FIG. 1;

FIGS. 5A and 5B are side views of movement of a carriage and a maintenance unit in some exemplary embodiments of this disclosure;

FIGS. 6A and 6B are side views of movement of a supply unit in some exemplary embodiments of this disclosure;

FIGS. 7A and 7B are side views of movement of the supply unit;

FIGS. 8A and 8B are plan views of movement of the supply unit;

FIGS. 9A and 9B are plan views of movement of the supply unit;

FIGS. 10A and 10B are back views of movement of the supply unit;

FIGS. 11A and 11B are back views of movement of the supply unit;

FIG. 12 is a front view of an image forming apparatus according to a comparative example;

FIG. 13 is a schematic block diagram of a controller of the image forming apparatus in some exemplary embodiments of this disclosure;

FIG. 14 is a flowchart of control performed on replacement of cartridges in some exemplary embodiments of this disclosure;

FIG. 15 is a flowchart of control performed on replacement of cartridges in some exemplary embodiments of this disclosure;

FIG. 16 is a flowchart of control performed on opening of a front cover in some exemplary embodiments of this disclosure;

FIG. 17 is a flowchart of control performed when the remaining amount of ink cartridges falls below a threshold amount in some exemplary embodiments of this disclosure;

FIG. 18 is a flowchart following the flowchart of FIG. 17;

FIG. 19 is a flowchart of control performed when cartridge replacement is instructed in some exemplary embodiments of this disclosure;

FIG. 20 is a flowchart of control from a standby state to a start of printing in some exemplary embodiments of this disclosure;

FIGS. 21A and 21B are side views of a portion of an image forming apparatus according to some exemplary embodiments of this disclosure; and

FIGS. 22A and 21B are side views of a portion of an image forming apparatus according to some exemplary embodiments of this disclosure.

The accompanying drawings are intended to depict exemplary embodiments of the present disclosure and should not be interpreted to limit the scope thereof. The accompanying drawings are not to be considered as drawn to scale unless explicitly noted.

### DETAILED DESCRIPTION OF EXEMPLARY EMBODIMENTS

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

For example, in this disclosure, the term “sheet” used herein is not limited to a sheet of paper and includes anything such as OHP (overhead projector) sheet, cloth sheet, glass sheet, or substrate on which ink or other liquid droplets can be attached. In other words, the term “sheet” is used as a generic term including a recording medium, a recorded medium, a recording sheet, and a recording sheet of paper. The terms “image formation”, “recording”, “printing”, “image recording” and “image printing” are used herein as synonyms for one another.

The term “image forming apparatus” refers to an apparatus that ejects liquid on a medium to form an image on the medium. The medium is made of, for example, paper, string, fiber, cloth, leather, metal, plastic, glass, timber, and ceramic. The term “image formation” includes providing not only meaningful images such as characters and figures but meaningless images such as patterns to the medium (in other words, the term “image formation” also includes only causing liquid droplets to land on the medium).

The term “ink” is not limited to “ink” in a narrow sense, unless specified, but is used as a generic term for any types of liquid usable as targets of image formation. For example, the term “ink” includes recording liquid, fixing solution, DNA sample, resist, pattern material, resin, and so on.

The term “image” used herein is not limited to a two-dimensional image and includes, for example, an image applied to a three dimensional object and a three dimensional object itself formed as a three-dimensionally molded image.

Although the exemplary embodiments are described with technical limitations with reference to the attached drawings, such description is not intended to limit the scope of the invention and all of the components or elements described in the exemplary embodiments of this disclosure are not necessarily indispensable to the present invention.

Referring now to the drawings, wherein like reference numerals designate identical or corresponding parts throughout the several views, exemplary embodiments of the present disclosure are described below.

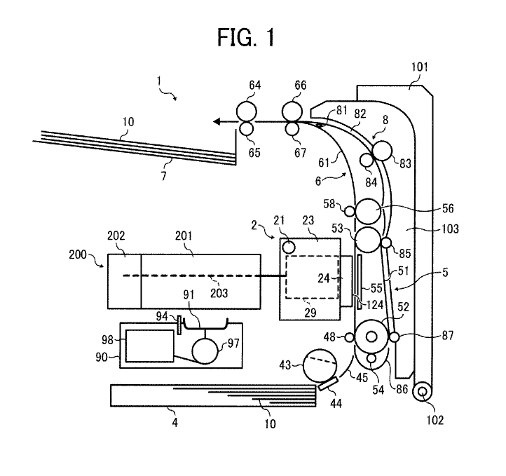

First, an image forming apparatus according to a first exemplary embodiment of this disclosure is described with reference to FIGS. 1 to 4.

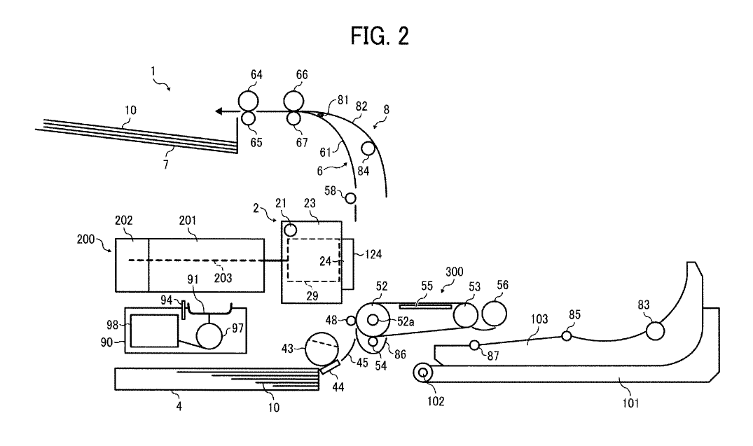

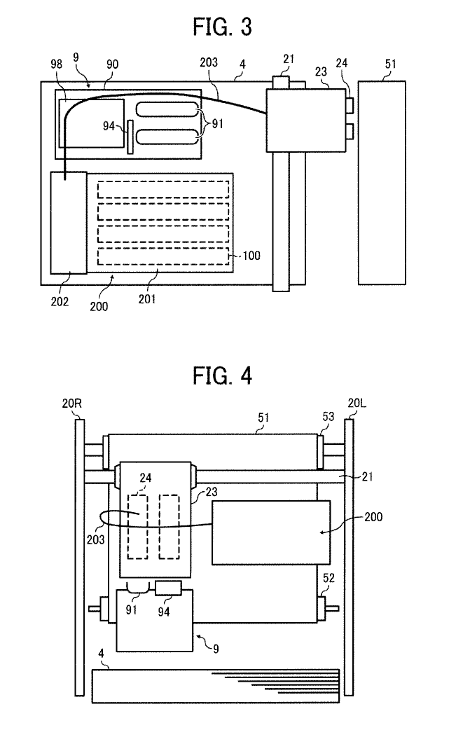

FIG. 1 is a side view of a mechanical section of an image forming apparatus according to some exemplary embodiments of this disclosure. FIG. 2 is a side view of the image forming apparatus of FIG. 1 in a state in which a cover is opened. FIG. 3 is a plan view of the image forming apparatus of FIG. 1. FIG. 4 is a back view of the image forming apparatus of FIG. 1.

The image forming apparatus illustrated in FIGS. 1 to 4 is a serial-type image forming apparatus and includes, e.g., an image forming device 2 serving as an image forming unit and a conveyance assembly 5 serving as a conveyance unit inside an apparatus body 1. The image forming apparatus also has a feed tray 4 serving as a sheet feeder to load sheets 10 serving as recording media at a lower side of the apparatus body 1. It is to be noted that the sheet feeder is not limited to the feed tray 4 illustrated in FIGS. 1 to 4. In some embodiments, the sheet feeder is, for example, a sheet feed cassette.

When a sheet 10 is fed from the feed tray 4, the conveyance assembly 5 receives the sheet 10. While the sheet 10 is intermittently conveyed in a vertical direction by the conveyance assembly 5, the image forming device 2 ejects liquid droplets in horizontal direction to record a desired image on the sheet 10. The sheet 10 having the desired image formed thereon is further conveyed upward through an output conveyance unit 6, and discharged onto an output tray 7 serving as an output unit.

For duplex printing (double-face printing), after printing on one face (front face) ends, a reverse unit 8 receives the sheet 10 from the output conveyance unit 6. While conveying the sheet 10 in the opposite direction (downward direction), the conveyance assembly 5 turns around and feeds the sheet 10 toward the image forming device 2 again so that the image forming device 2 can print on the other face (back face) of the sheet 10. After printing on the other face (back face) ends, the output conveyance unit 6 outputs the sheet 10 to the output tray 7.

In the image forming device 2, a carriage 23 mounting at least one recording head 24 is movably supported by a main guide member 21 and a sub guide member extending between a left side plate 101L and a right side plate 101R. A main scanning motor 25 of a carriage moving assembly moves the carriage 23 for scanning in a main scanning direction via a timing belt looped between a driving pulley and a driven pulley.

The carriage 23 mounts, for example, recording heads 24a and 24b (referred to as “recording heads 4” unless distinguished) serving as liquid ejection heads to eject ink droplets of different colors, e.g., yellow (y), magenta (m), cyan (c), and black (k).

The recording heads 24a and 24b having nozzle rows are mounted on the carriage 23 so that multiple nozzles forming each of the nozzle rows are arrayed in line in a sub scanning direction perpendicular to the main scan direction and ink droplets are ejected from the nozzles in the horizontal direction. In other words, the image forming apparatus employs a horizontal ejection method in which a nozzle face having multiple nozzles in each recording head 24 is oriented in the vertical direction to eject liquid droplets in the horizontal direction.

Each recording head 24 has, for example, two nozzle rows, each of which multiple nozzles are arrayed in line to eject liquid droplets. For example, the recording head 24a ejects droplets of yellow (Y) from one of the nozzle rows and droplets of magenta (M) from the other of the nozzle rows. In addition, the recording head 24b ejects droplets of black (K) from one of the nozzle rows and droplets of cyan (C) from the other of the nozzle rows.

The carriage 23 mounts head tanks 29 to supply the respective color inks to the corresponding nozzle rows of the recording heads 24.

A supply unit 200 is disposed at a back face side of the carriage 23 to supply inks to the head tanks 29. The supply unit 200 has a cartridge unit 201 to replaceably accommodate ink cartridges 100 serving as liquid cartridges and a supply pump 202 to deliver ink stored in the ink cartridges 100. The supply pump 202 delivers ink to the recording heads 24 via a supply tube 203.

A maintenance unit 9 is disposed below the image forming device 2 and the supply unit 200 at a position opposite a position of the conveyance assembly 5 via the image forming device 2. The maintenance unit 9 serves as a maintenance device to perform maintenance operations to maintain and recover good conditions of the recording heads 24.

The sheets 10 in the feed tray 4 are separated by a sheet feed roller (half-moon-shaped roller) 43 and a separation pad 44 and fed sheet by sheet into the apparatus body 1. The sheet 10 is sent along a conveyance guide member 45 to between a conveyance belt 51 and a regulation roller 48, and attached to and conveyed by the conveyance belt 51.

The conveyance assembly 5 includes, e.g., the conveyance belt 51, a conveyance roller 52, a driven roller 53, and a charging roller 54. The conveyance belt 51 has an endless shape and is looped around the conveyance roller 52, serving as a driving roller, and the driven roller 53. The charging roller 54 charges the conveyance belt 51. The conveyance assembly 5 also has a platen member 55, a conveyance roller 56, and a spur wheel 58. The platen member 55 is disposed at a position opposing the image forming device 2 to maintain flatness of the conveyance belt 51. The conveyance roller 56 is disposed opposing the spur wheel 58.

The conveyance roller 52 is rotated by a sub-scanning motor via a timing belt and a timing pulley. By rotation of the conveyance roller 52, the conveyance belt 51 is moved for circulation in a belt conveyance direction (also referred to as sub-scanning direction or sheet conveyance direction).

The output conveyance unit 6 includes an output guide member 61, an output conveyance roller 62, a spur wheel 63, an output conveyance roller 66, a spur wheel 67, an output roller 64, and a spur wheel 65. The output conveyance unit 6 discharges the sheet 10 having an image formed, from between the output roller 64 and the spur wheel 65 onto the output tray 7 in a face-down manner.

The reverse unit 8 sends the sheet 10, which is partially discharged to the output tray 7, back to between the conveyance belt 51 and the regulation roller 48 while turning the sheet 10 upside down in a switchback manner. The reverse unit 8 has a switching claw 81 to switch between an output passage and a reverse passage, a reverse guide member 82, a conveyance roller 83, and a spur wheel 84 serving as a reverse roller.

The reverse unit 8 also has an auxiliary conveyance roller 85 opposing the driven roller 53 and an auxiliary conveyance roller 87 opposing the conveyance roller 52. The reverse unit 8 also has a bypass guide member 86. When the sheet 10 is separated from between an opposite conveyance area of the conveyance belt 51 (in which the sheet 10 is conveyed in a direction opposite the sheet conveyance direction) and the auxiliary conveyance roller 87, the bypass guide member 86 guides the sheet 10 to between the conveyance belt 51 and the regulation roller 48.

In the image forming apparatus having the above-described configuration, the sheet 10 is separately fed from the feed tray 4, is electrostatically attached onto the conveyance belt 51 charged by the charging roller 54, and conveyed in the vertical direction by the circulation of the conveyance belt 51. By driving the recording heads 24 in accordance with image signals while moving the carriage 23, ink droplets are ejected onto the stopped sheet 10 to form one line of a desired image. The sheet 10 is fed by a certain distance to prepare for recording another line of the image. After the recording of the image is completed, the sheet 10 is discharged to the output tray 7.

For duplex printing, a first face of a sheet 10 is printed in the same manner as described above. When a rear edge of the sheet 10 passes a branching part (switching claw 81) of the reverse unit 8, the output roller 64 is rotated in reverse to switch the sheet 10 back. Further, the sheet 10 is guided toward the reverse guide member 82, conveyed to between the conveyance roller 83 and the spur wheel 84, and sent into between the opposite conveyance area of the conveyance belt 51 and the auxiliary conveyance roller 85.

As a result, the sheet 10 is attached onto the conveyance belt 51 by static electricity, conveyed by the circulation of the conveyance belt 51, separated from the conveyance belt 51 at the conveyance roller 52, guided by the bypass guide member 86, and sent into between the normal conveyance area of the conveyance belt 51 and the regulation roller 48. Then, the sheet 10 is adhered onto the conveyance belt 51 and conveyed again to an image formation area in which image formation is performed by the recording heads 24. After a second face of the sheet 10 is printed, the sheet 10 is output to the output tray 7.

Next, a configuration of opening a conveyance unit of the image forming apparatus is described below.

At a front face side of the apparatus body 1, the front cover 101 serving as an opening and closing cover is disposed so as to be openable and closable around a support shaft 102 serving as a fulcrum disposed at a lower end of the front cover 101. On the front cover 101 are mounted a guide member 103 to form a reverse passage, the conveyance roller 83, and the auxiliary conveyance rollers 85 and 87.

The conveyance belt 51, the conveyance roller 52, the driven roller 53, the conveyance roller 56, and the platen member 55 are integral parts of a conveyance unit 300. The conveyance unit 300 is openable and closable (swingable) around a support shaft 52a of the conveyance roller 52 serving as a fulcrum.

Thus, by opening the front cover 101 and the conveyance unit 300, an opening 301 is formed at a front face side in the apparatus body 1. The ink cartridges 100 are inserted into and extracted from the cartridge unit 201 through the opening 301.

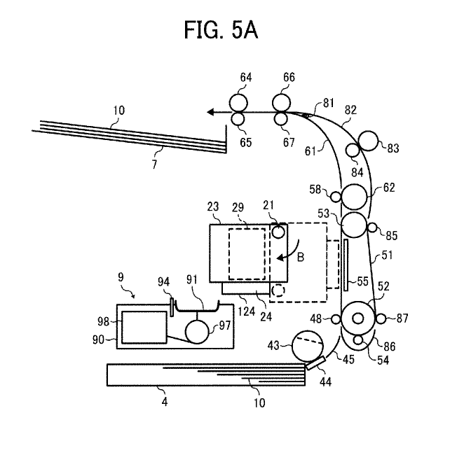

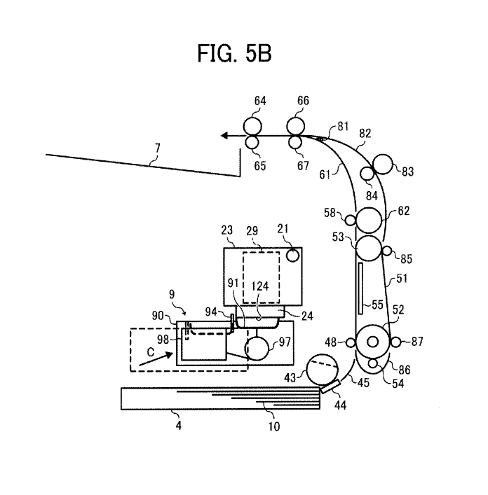

Next, a configuration relating to maintenance is described with reference to FIGS. 5A and 5B.

FIGS. 5A and 5B are side views of movement of the carriage and the maintenance unit.

In FIGS. 5A and 5B, the maintenance unit 9 is disposed below the image forming device 2 and at a position opposite a position of the conveyance assembly 5 via the image forming device 2. The maintenance unit 9 serves as a maintenance device to perform maintenance operations to maintain and recover good conditions of the recording heads 24.

In other words, the feed tray 4 (feed unit) 4 is disposed below the apparatus body 1 to feed a recording medium (sheet 10). At an upper portion of the apparatus body 1 is disposed the output tray 7 serving as the output unit to output the recording medium having an image formed by the image forming device 2. The image forming device 2 and the maintenance unit 9 are disposed in a space surrounded by the feed tray 4, the output tray 7, and the conveyance assembly 5. The maintenance unit 9 is disposed below the image forming device 2.

The maintenance unit 9 has a frame 90 provided with caps 91 to cap nozzle faces 124 of the recording heads 24 and a wiping member (wiping blade) 94 to wipe the nozzle faces 124 of the recording heads 24. The maintenance unit 9 also has, e.g., a suction pump 97 serving as a suction device connected to the caps 91 and a waste liquid tank 98 connected to the suction pump 97.

The carriage 23 mounting the recording heads 24 of the image forming device 2 is displaceable between an image forming position indicated by a broken line in FIG. 5A and a maintenance position indicated by a solid line in FIGS. 5A and 5B. The recording heads 24 eject liquid droplets in the horizontal direction at the image forming position and are opposable to the maintenance unit 9 at the maintenance position.

In the configuration of FIGS. 5A and 5B, since the maintenance unit 9 is disposed lower than the image forming device 2, the recording heads 24 are rotated by 90 degrees downward from the image forming position to the maintenance position so that the nozzle faces 124 are directed downward.

The driving motor (main scanning motor) moves the carriage 23 for scanning in the main scanning direction. Driving force of the main scanning motor is transmitted via a clutch assembly to rotate the carriage 23, thus resulting in a reduced number of components.

The maintenance unit 9 is movable between a maintenance position indicated by the solid line in FIG. 5B and a retracted position indicated by a solid line in FIG. 5A (i.e., a broken line in FIG. 5B). The caps 91 cap the nozzle faces 124 of the recording heads 24 at the maintenance position. The maintenance unit 9 is retracted from the maintenance position to the retracted position.

The driving motor (sub-scanning motor) moves the conveyance belt 51 in the sub-scanning direction. Driving force of the sub-scanning motor is transmitted via a clutch assembly to move the maintenance unit 9, thus resulting in a reduced number of components.

Next, movement of the carriage 23 and the maintenance unit 9 is described below.

For example, when nozzles of the recording heads 24 are clogged or negative pressure in the head tanks 29 is not maintained, thus breaking menisci of nozzles, cleaning operation (maintenance operation) is performed. The cleaning operation includes sucking operation, wiping operation, and dummy ejection operation. For example, the sucking operation is performed in an order of capping, ink suction, decapping, and suction of the interior of the caps.

As illustrated in FIG. 5A, the carriage 23 is rotated by substantially 90 degrees in a direction indicated by an arrow B from the image forming position indicated by the broken line to maintenance position indicated by the solid line. Thus, the nozzle faces 124 are moved so as to direct downward.

Then, as illustrated in FIG. 5B, the maintenance unit 9 is moved obliquely upward in a direction indicated by an arrow C from the retracted position to the maintenance position, to cap the nozzle faces 124 of the recording heads 24 with the caps 91. In some embodiments, after the maintenance unit 9 is moved in the horizontal direction, the maintenance unit 9 is moved upward in the vertical direction. Alternatively, in some embodiments, after the maintenance unit 9 is moved upward in the vertical direction, the maintenance unit 9 is moved in the horizontal direction.

The suction pump 97 is driven to suck a predetermined amount of liquid (ink) from the nozzles of the recording heads 24 into the caps 91, thus discharging liquid into the caps 91.

The maintenance unit 9 is moved to a position at which the caps 91 are placed away (decapped) from the nozzle faces 124 of the recording heads 24.

The suction pump 97 is activated again to suck residual waste liquid remaining in the caps 91 to discharge the waste liquid into the waste liquid tank 98.

Then, the wiping member 94 is moved to a wipable position at which the wiping member 94 can wipe the nozzle faces 124 of the recording heads 24, and starts to wipe the nozzle faces 124. A wiping direction of the wiping member 94 may be any of a longitudinal direction and a lateral direction relative to the nozzle rows.

After the wiping member 94 wipes the nozzle faces 124, the caps 91 are placed under the nozzle faces 124 of the recording heads 24 and the recording heads 24 performs dummy ejection to eject droplets to the inside of the caps 91. After the dummy ejection, the suction pump 97 is activated to suck waste liquid from the inside of the caps 91 and discharge the waste liquid into the waste liquid tank 98.

The maintenance unit 9 is moved obliquely downward to the retracted position indicated by the solid line in FIG. 5A.

As described above, the maintenance unit 9 is disposed within the space surrounded by the feed tray 4, the output tray 7, and the conveyance assembly 5 and at a side opposite the conveyance assembly 5 via the image forming device 2 (a side opposite the droplet ejected direction with respect to the recording heads 24). Such a configuration reduces the size of the apparatus body in the width direction, thus allowing downsizing.

In addition, the caps 91 of the maintenance unit 9 are directed upward. Such a configuration prevents liquid from leaking from the caps 91 even when liquid is discharged into the caps 91.

In other words, if, with the nozzle faces 124 held in a vertical state and capped with caps, liquid is discharged into the caps, waste liquid would drip down from the caps when the caps are decapped from the nozzle faces 124. Hence, for example, it is conceivable to provide the caps with air release valves to release liquid from the inside of the caps and then open the inside of the caps relative to the atmosphere. After the inside of the caps are opened to the atmosphere, waste liquid remaining in the caps are sucked and discharged by the suction pump, and then the caps are decapped from the nozzle faces. Consequently, the configuration and operation are complicated and, even when waste liquid in the caps is discharged by suction, residual waste liquid would remain in the caps, thus resulting in dropping of waste liquid from the caps.

By contrast, in the above-described configuration, liquid is discharged into the caps 91 with the caps 91 directed upward, thus preventing waste liquid from dropping from the caps.

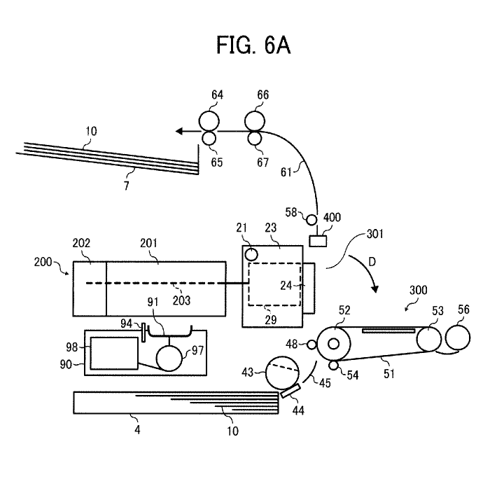

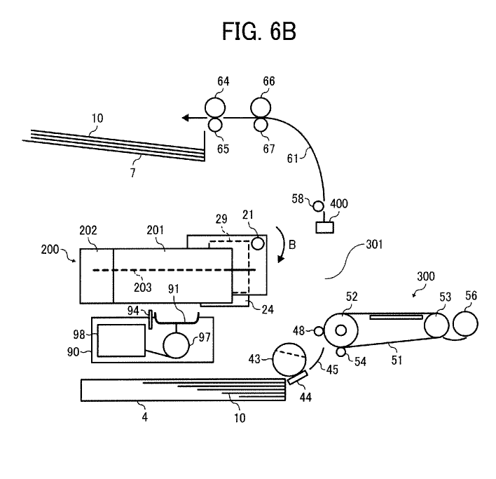

Next, a configuration of the supply unit 200 is further described with reference to FIGS. 6A to 11B.

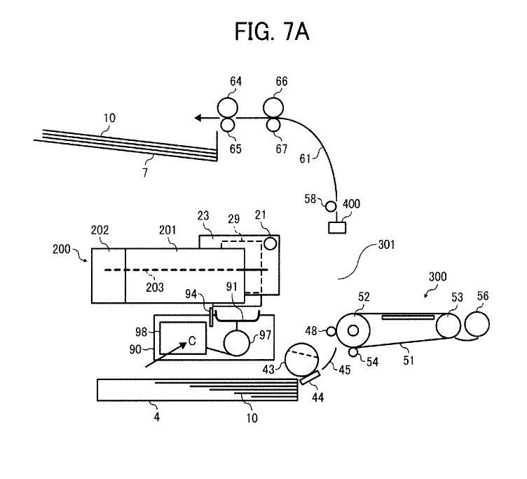

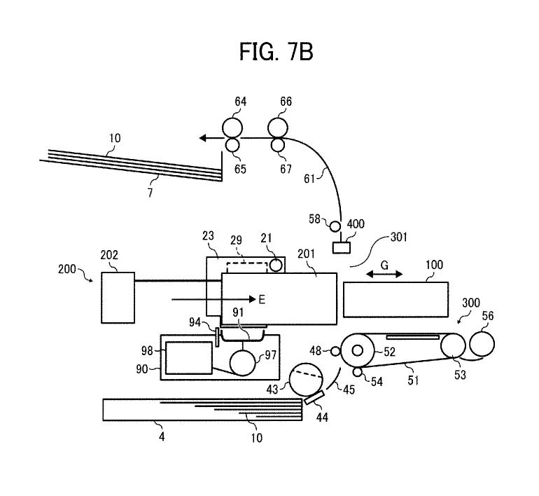

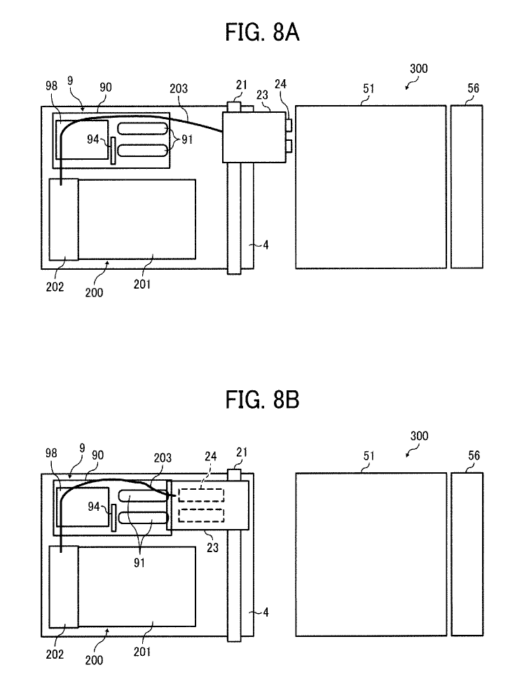

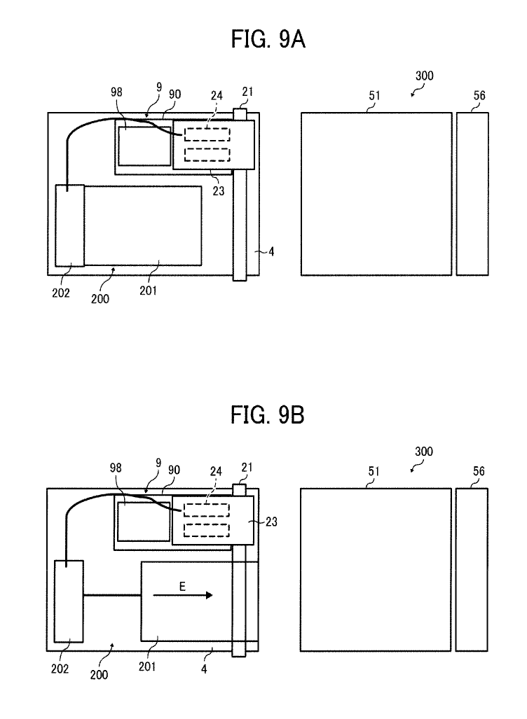

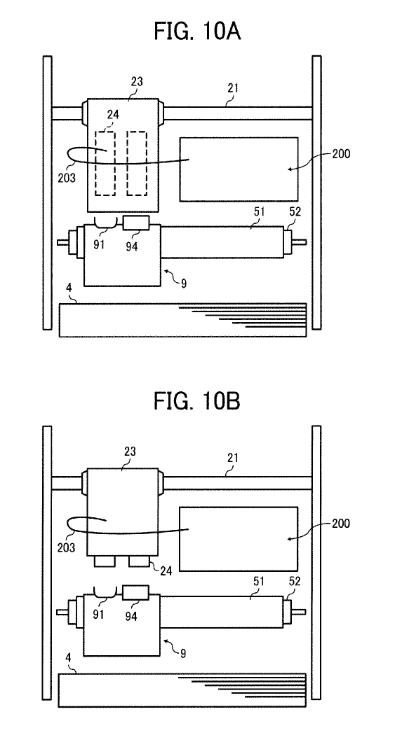

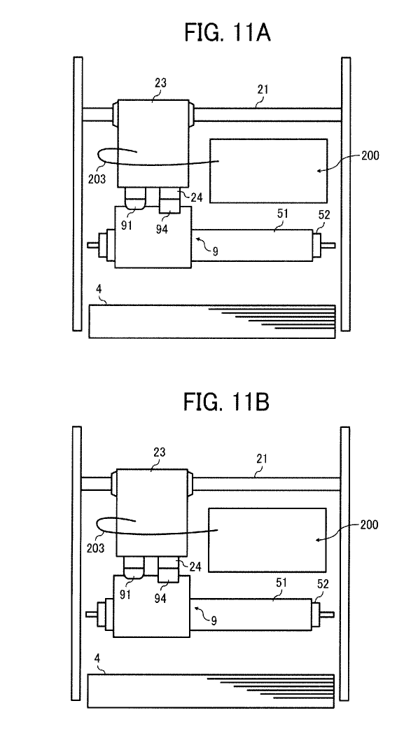

FIGS. 6A and 6B and 7A and 7B are side views of movement of the supply unit in some exemplary embodiments of this disclosure. FIGS. 8A and 8B and 9A and 9B are plan views of the supply unit. FIGS. 10A and 10B and 11A and 11B are plan views of the supply unit.

As described above, the supply unit 200 has the cartridge unit 201 to replaceably accommodate the ink cartridges 100 serving as liquid cartridges and the supply pump 202 to deliver ink stored in the ink cartridges 100.

The cartridge unit 201 is movable between a supply position shown in FIG. 1 (FIG. 6A, FIG. 8A, and FIG. 10A) and a replacement position shown in FIG. 7B, FIG. 9B, and FIG. 11B. At the supply position, the cartridge unit 201 is placed outside a movement range of the carriage 23 so as not to interfere with the movement range of the carriage 23. At the replacement position, the cartridge unit 201 is placed within the movement range of the carriage 23 so as to interfere with the movement range of the carriage 23.

When the carriage 3 moves, the cartridge unit 201 is moved to the supply position. When the ink cartridges 100 are replaced, the cartridge unit 201 is moved to the replacement position.

Operation in replacement of the ink cartridges 100 is described below.

As illustrated in FIG. 6A, FIG. 8A, and FIG. 10A, when a user opens the front cover 101 in a direction indicated by an arrow D, a front-cover opening-and-closing sensor 400 serving as a cover sensor detects that the front cover 101 is opened and the conveyance unit 300 is opened.

When the front cover 101 is opened and the conveyance unit 300 is opened, the opening 301 is formed at the front side of the apparatus body 1.

Then, as illustrated in FIG. 8A, the carriage 3 is moved toward the maintenance unit 9 (to the home position).

As illustrated in FIG. 6B, the carriage 3 is rotated by substantially 90 degrees in the direction indicated by the arrow B and moved so as to direct the nozzle faces 124 downward (see also FIGS. 8B and 10B).

Next, as illustrated in FIG. 7A, the maintenance unit 9 is moved obliquely upward in the direction indicated by the arrow C to cap the nozzle faces 124 of the recording heads 24 (see also FIGS. 9A and 11A).

Then, as illustrated in FIG. 7B, the cartridge unit 201 is moved toward the front side of the apparatus body 1 in a direction indicated by an arrow E and placed at the replacement position. It is to be noted that the supply pump 202 is not moved.

At this time, the conveyance unit 300 and the front cover 101 are opened, and as described above, the opening 301 is opened. Through the opening 301, the ink cartridges 100 are inserted into and extracted from the cartridge unit 201 from the front side of the apparatus body 1.

Hence, a user can access to the interior of the apparatus body 1 from at the front face side of the apparatus body 1 to insert or extract the ink cartridges 100 along a direction indicated by an arrow G in FIG. 7B to replace the ink cartridges 100.

When the front cover 101 is closed after replacement of the ink cartridges 100, the front-cover opening-and-closing sensor 400 detects closing of the front cover 101 and the cartridge unit 201 is moved to the supply position at a rear side of the apparatus body 1 (the position of the cartridge unit 201 shown in FIG. 6A, FIG. 8A, and FIG. 10A).

As described above, the cartridge unit is provided to replaceably mount the liquid cartridges to store liquid to be supplied to the recording heads. The cartridge unit is movable between the supply position at which the cartridge unit does not interfere with the movement range of the carriage and the replacement position at which the cartridge unit interferes with the movement range of the carriage. When the carriage is moved, the cartridge unit is moved to the supply position. When the liquid cartridges are replaced, the cartridge unit moved to the replacement position. Such a configuration allows downsizing of the apparatus body in the lateral direction and the longitudinal direction. When the ink cartridges are replaced, the cartridge unit is moved to the front cover side, thus facilitating replacement operation.

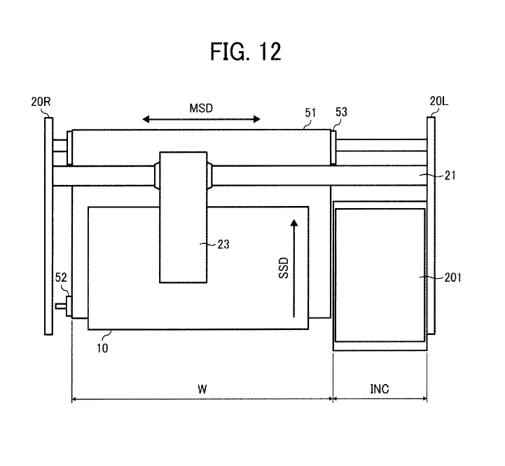

In other words, as in a comparative example shown in FIG. 12, in a configuration in which a supply unit 200 is disposed outside a width W of a sheet conveyance path in a lateral direction (main scanning direction indicated by an arrow MSD) of an apparatus body, the apparatus body has a size increased by a width of the supply unit 200 in the lateral direction.

By contrast, in the above-described configuration, the supply unit 200 is disposed at a position overlapping the sheet conveyance path in the main scanning direction. Such a configuration obviates a width corresponding to an increased size (INC) shown in FIG. 12, thus reducing the size of the apparatus body in the width direction (main scanning direction MSD perpendicular to a sub-scanning direction indicated by an arrow SSD in FIG. 12).

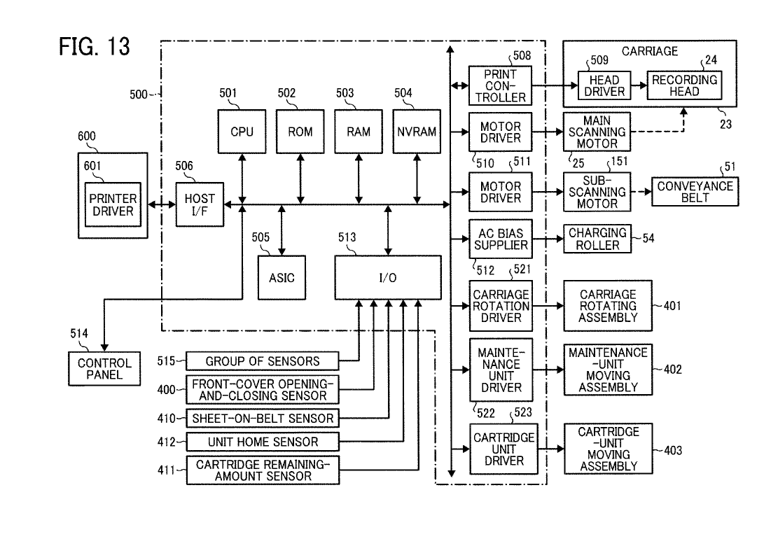

Next, a controller of the image forming apparatus in some exemplary embodiments is described with reference to FIG. 13.

FIG. 13 is a block diagram of a controller 500 of the image forming apparatus in some exemplary embodiments.

The controller 500 includes a central processing unit (CPU) 501, a read-only memory (ROM) 502, a random access memory (RAM) 503, a rewritable non-volatile memory 504, and an application specific integrated circuit (ASIC) 505. The CPU 501 controls the entire image forming apparatus. The ROM 502 stores programs, including programs causing the CPU 501 to perform control processing according to exemplary embodiments described below, and other fixed data. The RAM 503 temporarily stores image data or other data.

The rewritable non-volatile memory 504 retains data even while the apparatus is powered off. The ASIC 505 processes signals for image data, performs image processing, e.g., sorting, or processes input and output signals for controlling the entire image forming apparatus.

The controller 500 also has a print controller 508, a head driver (driver IC) 509, a motor driver 510, a motor driver 511, and an alternating current (AC) bias supplier 512. The print controller 508 includes a data transmitter and a driving signal generator to drive and control the recording heads 24 in accordance with print data. The head driver 509 drives the recording heads 24 mounted on the carriage 23.

The motor driver 510 and the motor driver 511 drive the main scanning motor 25 for moving the carriage 23 and the sub-scanning motor 151 for circulating the conveyance belt 51. The AC bias supplier 512 supplies AC bias to the charging roller 54.

The controller 500 further includes a carriage rotation driver 521, a maintenance-unit driver 522, and a cartridge-unit driver 523. The carriage rotation driver 521 drives a carriage rotating assembly 401 to rotate the carriage 3 around the main guide member 21. The maintenance-unit driver 522 drives a maintenance-unit moving assembly 402 to move the maintenance unit 9. The cartridge-unit driver 523 drives a cartridge-unit moving assembly 403 to move the cartridge unit 201.

The controller 500 is connected to a control unit 514 (e.g., control panel) to input and display information necessary to the image forming apparatus.

The controller 500 includes an interface (I/F) 506 to transmit and receive data and signals to and from a host 600, such as an information processing device (e.g., personal computer) via a cable or network.

The CPU 501 of the controller 500 reads and analyzes print data stored in a reception buffer of the I/F 506, performs desired image processing, data sorting, or other processing with the ASIC 505, and transmits image data to the head driver 509. It is to be noted that dot-pattern data for image output may be created by a printer driver 601 of the host 600.

The print controller 508 transmits the above-described image data as serial data and outputs to the head driver 509, for example, transfer clock signals, latch signals, and control signals required for the transmission of print data and determination of the transmission. The print controller 508 further includes a driving signal generator including, e.g., a digital/analog (D/A) converter to convert pattern data of driving pulses stored in the ROM 502 from digital to analog, a voltage amplifier, and a current amplifier. From the driving signal generator, driving signals of one or more driving pulses are output to the head driver 509.

In accordance with serially-input image data corresponding to one line of a desired image recorded by the recording heads 24, the head driver 509 selectively applies driving pulses constituting a driving signal transmitted from the print controller 508, to the recording heads 24 to drive the recording heads 24. At this time, by selecting driving pulses constituting the driving signal, liquid droplets of different liquid amounts, such as large-size droplets, medium-size droplets, and small-size droplets, can be selectively ejected to form different sizes of dots.

The I/O unit 513 obtains information from a group of sensors 515 mounted on a main scanning encoder, a sub-scanning encoder, and other devices. Information for controlling devices is extracted and used to control the print controller 508, the motor driver 510 and 511, and the AC bias supplier 512.

The I/O unit 513 also obtains information from the front-cover opening-and-closing sensor 400 to detect opening and closing of the front cover 101, a sheet-on-belt sensor 410 (serving as a media sensor) to detect whether a sheet is placed on the conveyance belt 51, and a cartridge remaining-amount sensor 411 to detect an amount of ink remaining in the ink cartridges 100. Information for controlling devices is extracted and used to control, e.g., the carriage rotation driver 521, the maintenance-unit driver 522, and the cartridge-unit driver 523.

The group of sensors 515 includes, for example, a sheet sensor to detect a sheet, a thermistor to monitor temperature and/or humidity in the apparatus body 1, and a voltage sensor to monitor the voltage of the conveyance belt charged. The I/O unit 513 processes information from such various types of sensors.

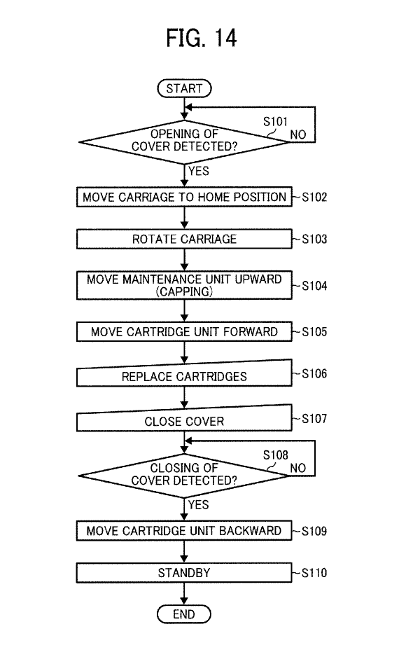

Next, control on replacement of ink cartridges according to some exemplary embodiments of this disclosure is described with reference to FIG. 14.

At S101, the front-cover opening-and-closing sensor 400 of the controller 500 determines whether or not the front cover 101 and the conveyance unit 300 are opened (cover opening detection).

When the front cover 101 and the conveyance unit 300 are opened (YES at S101), at S102 the controller 500 causes the carriage 3 to move to the home position and at 5103 drives the carriage rotating assembly 401 to rotate the carriage 3 downward.

At S104 the controller 500 drives the maintenance-unit moving assembly 402 to move the maintenance unit 9 obliquely upward to cap the nozzle faces of the recording heads 24 with the caps 91.

At S105, the controller 500 drives the cartridge-unit moving assembly 403 to move the cartridge unit 201 forward (to the replacement position).

At S106, a user replaces the ink cartridges 100 from the front side of the apparatus body 1 through the opening 301, and at S107 closes the front cover 101.

At S108, the front-cover opening-and-closing sensor 400 determines whether or not the front cover 101 and the conveyance unit 300 are closed (cover closing detection).

When the front-cover opening-and-closing sensor 400 detects that the front cover 101 and the conveyance unit 300 are closed (YES at S108), at S109 the controller 500 causes the cartridge unit 201 to move backward (to the supply position) and at S110 shifts to a standby state.

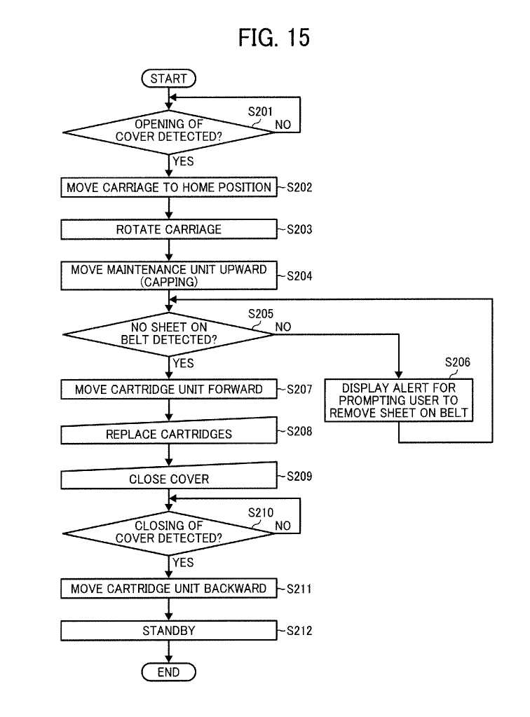

Next, control on replacement of ink cartridges according to some exemplary embodiments of this disclosure is described with reference to FIG. 15.

As in the above-described control of FIG. 14, when the front cover 101 and the conveyance unit 300 are opened (YES at S201), at S202 the controller 500 causes the carriage 23 to move to the home position and at S203 drives the carriage rotating assembly 401 to rotate the carriage 23 downward. At S204, the controller 500 drives the maintenance-unit moving assembly 402 to move the maintenance unit 9 obliquely upward to cap the nozzle faces of the recording heads 24 with the caps 91.

At S205, based on detection results of the sheet-on-belt sensor 410, the controller 500 determines whether or not a sheet 10 is placed on the conveyance belt 51.

When the controller 500 determines that no sheet 10 is placed on the conveyance belt 51 (YES at S205), as in the above-described control of FIG. 14, at S207 the controller 500 drives the cartridge-unit moving assembly 403 to move the cartridge unit 201 forward (to the replacement position) from the supply position (at the rear side of the apparatus body 1). At S208, a user replaces the ink cartridges 100 from the front side of the apparatus body 1 through the opening 301, and at S209 closes the front cover 101. When the front-cover opening-and-closing sensor 400 detects that the front cover 101 and the conveyance unit 300 are closed (YES at S210), at S211 the controller 500 causes the cartridge unit 201 to move backward (to the supply position) and at S212 shifts to a standby state.

By contrast, when the controller 500 determines that a sheet 10 is placed on the conveyance belt 51 (NO at S205), at S206 the controller 500 causes, e.g., the control unit 514 to display a sheet removal alert prompting a user to remove the sheet 10 on the conveyance belt 51. Such an alert may be displayed on, e.g., a screen of the printer driver 601 of the host 600. In other words, when the controller 500 determines that a sheet 10 is placed on the conveyance belt 51 (NO at S205), the controller 500 prohibits movement of the cartridge unit 201. Then, the process goes back to S205 and the controller 500 determines again whether or not a sheet 10 is placed on the conveyance belt 51.

When the sheet 10 is removed and the controller 500 determines that no sheet 10 is placed on the conveyance belt 51 (YES at S205), as described above, at S207 the controller 500 drives the cartridge-unit moving assembly 403 to move the cartridge unit 201 forward (to the replacement position). At S208, a user replaces the ink cartridges 100 from the front side of the apparatus body 1 through the opening 301.

To perform the above-described control process of FIG. 15, an image forming apparatus according to some exemplary embodiments of this disclosure has a sheet sensor (sheet-on-belt sensor) to detect whether or not a recording medium is placed on the conveyance belt and a mechanism to prohibit movement of the cartridge unit when the sheet sensor detects the recording medium. Such a configuration prevents a user from having difficulty in removing a jammed sheet because of the cartridge unit 201 moved to the opening 301 at occurrence of a sheet jam.

Such a configuration also prevents a reduction in replaceability of the ink cartridges due to a sheet remaining on the conveyance belt.

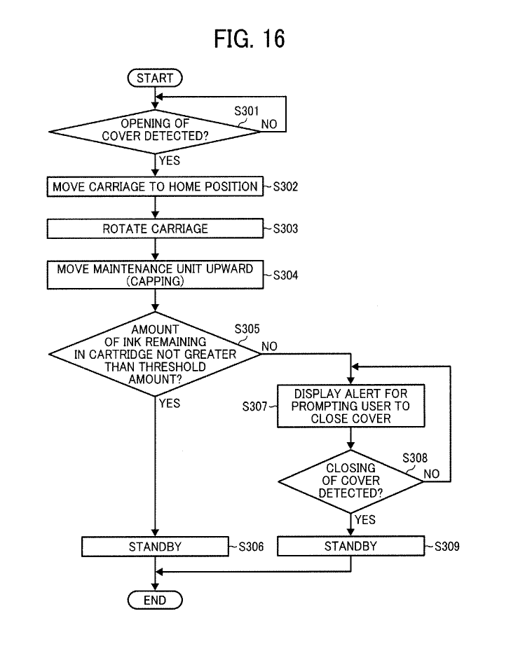

Next, control on replacement of ink cartridges according to some exemplary embodiments of this disclosure is described with reference to FIG. 16.

As in the above-described control of FIG. 14, when the front cover 101 and the conveyance unit 300 are opened (YES at S301), at S302 the controller 500 causes the carriage 23 to move to the home position and at S303 drives the carriage rotating assembly 401 to rotate the carriage 23 downward. At S304, the controller 500 drives the maintenance-unit moving assembly 402 to move the maintenance unit 9 obliquely upward to cap the nozzle faces of the recording heads 24 with the caps 91.

Based on detection results of the cartridge remaining-amount sensor 411, at S305 the controller 500 determines whether or not the remaining amount of ink in the ink cartridges 100 is not greater than a threshold amount. The threshold amount is defined as an amount at which the ink cartridges 100 are to be replaced.

At this time, if the remaining amount of ink in the ink cartridges 100 is greater than the threshold amount (NO at S305), the ink cartridges 100 need not be replaced. Therefore, the controller 500 causes, e.g., the control unit 514 to display a cover closing alert prompting a user to close the front cover 101, and shifts to a standby state when closing of the front cover 101 is detected.

For such a configuration, in a case in which the ink cartridges need not be replaced, the cartridge unit does not move to the front side even when the front cover is opened, thus suppressing an increase in power consumption due to wasteful movement of the cartridge unit. Such a configuration also saves a time for the movement of the cartridge unit, thus reducing a time for shifting to printing operation just after the front cover is closed.

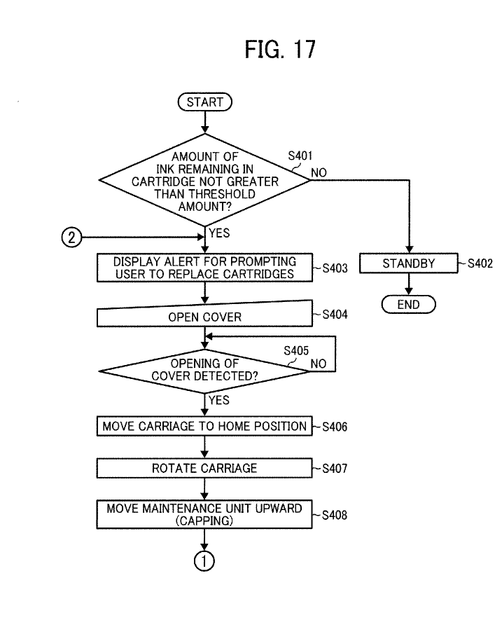

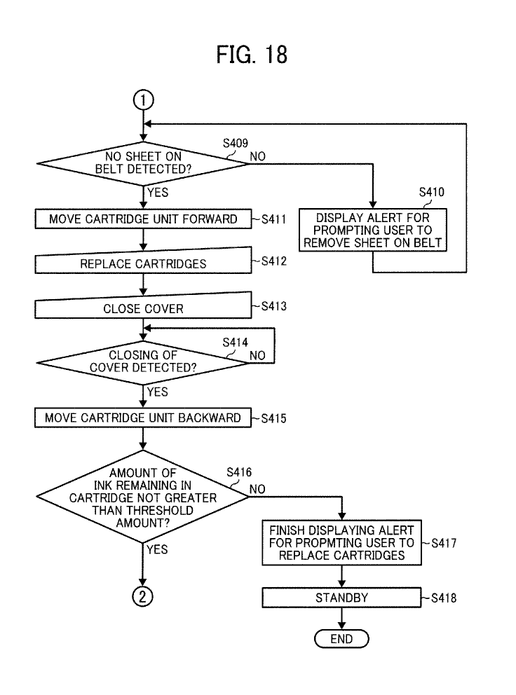

Next, control performed when the remaining amount of ink cartridges falls below a threshold amount in some exemplary embodiments of this disclosure is described with reference to FIGS. 17 and 18.

In FIG. 17, based on detection results of the cartridge remaining-amount sensor 411, at S401 the controller 500 determines whether or not the remaining amount of ink in the ink cartridges 100 is not greater than a threshold amount.

At this time, if the remaining amount of ink in the ink cartridges 100 is not greater than the threshold amount (YES at S401), at S403 the controller 500 causes, e.g., the control unit 514 to display a cartridge replacement alert prompting a user to replace the ink cartridges 100.

When the front cover 101 (and the conveyance unit 300) is (are) opened at S404, at S405 opening of the front cover 101 is detected. When opening of the front cover 101 is detected (YES at S405), at S406 the controller 500 causes the carriage 23 to move to the home position and at S407 drives the carriage rotating assembly 401 to rotate the carriage 23 downward. At S408, the controller 500 drives the maintenance-unit moving assembly 402 to move the maintenance unit 9 obliquely upward to cap the nozzle faces of the recording heads 24 with the caps 91.

The process goes to processing shown in FIG. 18 and at S409 the controller 500 determines whether or not a sheet 10 is placed on the conveyance belt 51.

When the controller 500 determines that no sheet 10 is placed on the conveyance belt 51 (YES at S409), at S411 the controller 500 drives the cartridge-unit moving assembly 403 to move the cartridge unit 201 forward (to the replacement position) from the supply position (at the rear side of the apparatus body 1). At S412, a user replaces the ink cartridges 100 from the front side of the apparatus body 1 through the opening 301, and at S413 closes the front cover 101. When the front-cover opening-and-closing sensor 400 detects that the front cover 101 and the conveyance unit 300 are closed (YES at S414), at S415 the controller 500 causes the cartridge unit 201 to move backward (to the supply position) and shifts to a standby state.

By contrast, when the controller 500 determines that a sheet 10 is placed on the conveyance belt 51 (NO at S409), at S410 the controller 500 causes, e.g., the control unit 514 to display the sheet removal alert prompting a user to remove the sheet 10 on the conveyance belt 51. Such an alert may be displayed on, e.g., a screen of the printer driver 601 of the host 600. Then, the process goes back to S409 and the controller 500 determines again whether or not a sheet 10 is placed on the conveyance belt 51.

When the sheet 10 is removed and the controller 500 determines that no sheet 10 is placed on the conveyance belt 51 (YES at S409), as described above, at S411 the controller 500 drives the cartridge-unit moving assembly 403 to move the cartridge unit 201 forward (to the replacement position). At S412, a user replaces the ink cartridges 100 from the front side of the apparatus body 1 through the opening 301.

At S416 the controller 500 determines whether or not the remaining amount of ink in the ink cartridges 100 is not greater than a threshold amount.

At this time, if the remaining amount of ink in the ink cartridges 100 is greater than the threshold amount (NO at S416), the controller 500 stops displaying the cartridge replacement alert on the control unit 514 and at S418 shifts to the standby state.

By contrast, if the remaining amount of ink in the ink cartridges 100 is not greater than the threshold amount (YES at S416), the process goes to S403 of FIG. 17 and the controller 500 causes, e.g., the control unit 514 to display the cartridge replacement alert.

As described above, in the control process of FIGS. 17 and 18, when the remaining amount of ink in the ink cartridges falls below a threshold amount, the controller 500 prompts a user to replace the ink cartridges and detects the remaining amount of ink in the ink cartridges after the replacement. Such a process prevents a reduction in image quality due to a sudden ink shortage.

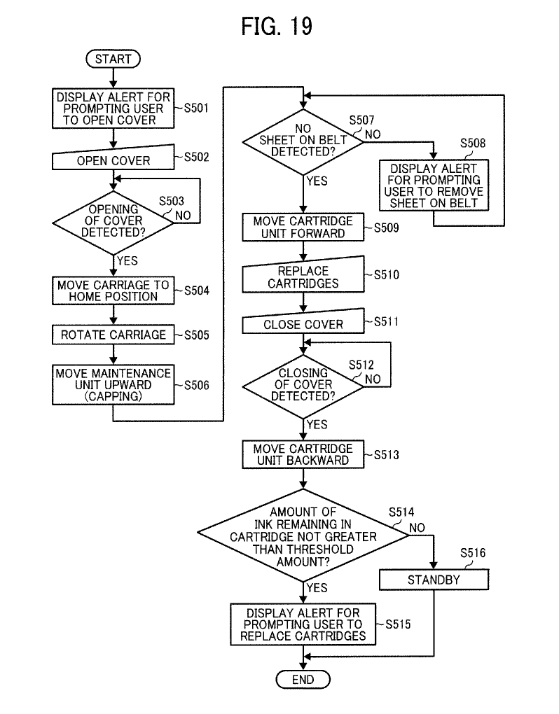

Next, control performed when replacement of ink cartridges are instructed in some exemplary embodiments of this disclosure is described with reference to FIG. 19.

To perform a control process of FIG. 19, an image forming apparatus according to some exemplary embodiments of this disclosure has a device (including, e g., menu selection keys or buttons) to instruct cartridge replacement.

When cartridge replacement is instructed, at S501 the controller 500 causes, e.g., the control unit 514 to display a cover opening alert prompting a user to open the front cover 101.

When the front cover 101 (and the conveyance unit 300) is (are) opened at S502, at S503 opening of the front cover 101 is detected. When opening of the front cover 101 is detected (YES at S503), at S504 the controller 500 causes the carriage 23 to move to the home position and at S505 drives the carriage rotating assembly 401 to rotate the carriage 23 downward. At S506, the controller 500 drives the maintenance-unit moving assembly 402 to move the maintenance unit 9 obliquely upward to cap the nozzle faces of the recording heads 24 with the caps 91.

At S507 the controller 500 determines whether or not a sheet 10 is placed on the conveyance belt 51.

When the controller 500 determines that no sheet 10 is placed on the conveyance belt 51 (YES at S507), at S509 the controller 500 drives the cartridge-unit moving assembly 403 to move the cartridge unit 201 forward (to the replacement position) from the supply position (at the rear side of the apparatus body 1). At S510, a user replaces the ink cartridges 100 from the front side of the apparatus body 1 through the opening 301, and at S511 closes the front cover 101. When the front-cover opening-and-closing sensor 400 detects that the front cover 101 and the conveyance unit 300 are closed (YES at S512), at S513 the controller 500 causes the cartridge unit 201 to move backward (to the supply position) and shifts to a standby state.

By contrast, when the controller 500 determines that a sheet 10 is placed on the conveyance belt 51 (NO at S507), at S508 the controller 500 causes, e.g., the control unit 514 to display an alert for prompting a user to remove the sheet 10 on the conveyance belt 51. Such an alert may be displayed on, e.g., a screen of the printer driver 601 of the host 600. Then, the process goes back to S507 and the controller 500 determines again whether or not a sheet 10 is placed on the conveyance belt 51.

When the sheet 10 is removed and the controller 500 determines that no sheet 10 is placed on the conveyance belt 51 (YES at S507), as described above, at S509 the controller 500 drives the cartridge-unit moving assembly 403 to move the cartridge unit 201 forward (to the replacement position). At S510, a user replaces the ink cartridges 100 from the front side of the apparatus body 1 through the opening 301.

At S514 the controller 500 determines whether or not the remaining amount of ink in the ink cartridges 100 is not greater than a threshold amount.

At this time, if the remaining amount of ink in the ink cartridges 100 is greater than the threshold amount (NO at S5146), at S516 the controller 500 shifts to a standby state.

By contrast, if the remaining amount of ink in the ink cartridges 100 is not greater than the threshold amount (YES at S514), at S515 the controller 500 causes, e.g., the control unit 514 to display the cartridge replacement alert.

For such a configuration, even when the remaining amount of ink in the ink cartridges 100 is greater than a threshold amount, the ink cartridges 100 can be replaced for a user's convenience, thus preventing a reduction in replaceability.

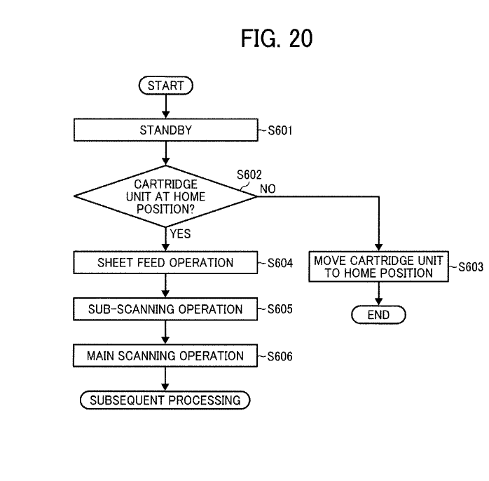

Next, control performed from a standby state to a start of printing in some exemplary embodiments of this disclosure is described with reference to FIG. 20.

To perform a control process of FIG. 20, an image forming apparatus according to some exemplary embodiments of this disclosure has a unit home sensor 412 (see FIG. 13) to detect whether or not the cartridge unit 201 is placed at the supply position.

At S601, the controller 500 shifts to a standby state as described in the above-described control processes. When the controller 500 starts printing, at S602 the controller 500 determines whether or not the cartridge unit 201 is placed at the home position (supply position).

When the cartridge unit 201 is placed at the home position (YES at S602), the controller 500 performs, e.g., sheet feed operation at S604, sub-scanning operation at S605, and main scanning operation at S606, and shifts to printing operation or other subsequent operation.

By contrast, when the cartridge unit 201 is not placed at the home position (NO at S602), at S603 the controller 500 drives the cartridge-unit moving assembly 403 to move the cartridge unit 201 to the home position.

As described above, in the control process of FIG. 20, the controller 500 determines whether or not the cartridge unit 201 is placed at the supply position (home position), and performs printing operation to move the carriage 23 when the cartridge unit is placed at the supply position. Such a configuration prevents interference of the carriage operation with the cartridge unit, thus preventing a reduction in reliability of the image forming apparatus.

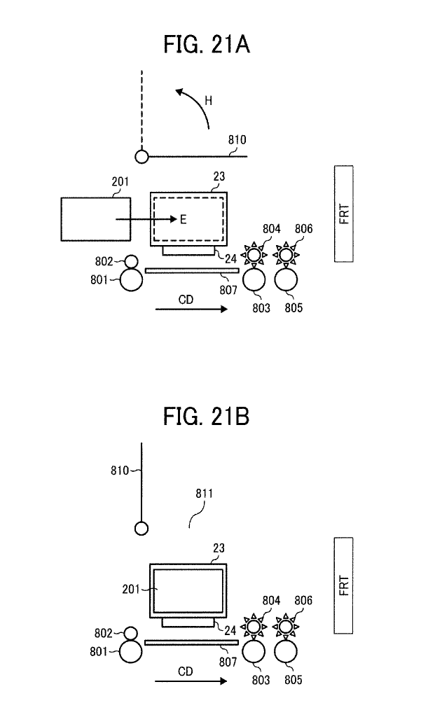

Next, an image forming apparatus according to some exemplary embodiments of this disclosure is described with reference to FIGS. 21A and 21B.

FIGS. 21A and 21B are partial side views of an image forming apparatus according to some exemplary embodiments of this disclosure.

In FIGS. 21A and 21B, recording heads 24 are mounted on a carriage 23 in such a state that the recording heads 24 eject liquid droplets downward in a vertical direction. A conveyance roller 801 and a driven roller 802 conveys a recording medium so that the recording medium opposes the recording heads 24. A conveyance roller 803 and a spur roller 804 and a conveyance roller 805 and a spur roller 806 feed the recording medium, on which an image has been formed by the recording heads 24, toward a front side FRT of an apparatus body in a conveyance direction CD. A guide member 807 is disposed opposing the recording heads 24 to guide the recording medium.

At an upper portion of the apparatus body is disposed an upper cover 810 serving as an opening-and-closing cover to open and close an upper area of the carriage 23. The upper cover 810 is openable and closable between a closed position indicated by a solid line of FIG. 21A and an open position indicated by a broken line of FIG. 21A (i.e., a position of the upper cover 810 in FIG. 21B).

A cartridge unit 201 is disposed at a position closer to a rear end of the apparatus body than the carriage 23. The cartridge unit 201 is movable between a supply position indicated by a solid line in FIG. 21A and a replacement position indicated by a broken line in FIG. 21A (i.e., a position of the cartridge unit 201 in FIG. 21B). The cartridge unit 201 does not interfere with a movement range of the carriage 23 and interferes with the movement range of the carriage 23.

As shown in FIGS. 21A and 21B, when ink cartridges in the cartridge unit 201 are replaced, the upper cover 810 is opened in a direction indicted by an arrow H and placed at the open position shown in FIG. 21B. When opening of the upper cover 810 is detected, the carriage 23 is moved to a home position (in a direction toward a rear side of a sheet face on which FIGS. 21A and 21B are printed).

From the supply position on a rear side of the apparatus body, the cartridge unit 201 is moved in a direction indicated by an arrow E in FIG. 21A and placed at the replacement position closer to the front side FRT of the apparatus body as shown in FIG. 21B.

Accordingly, from the upper area of the cartridge unit 201, ink cartridges can be replaced through an opening 811 formed by opening the upper cover 810.

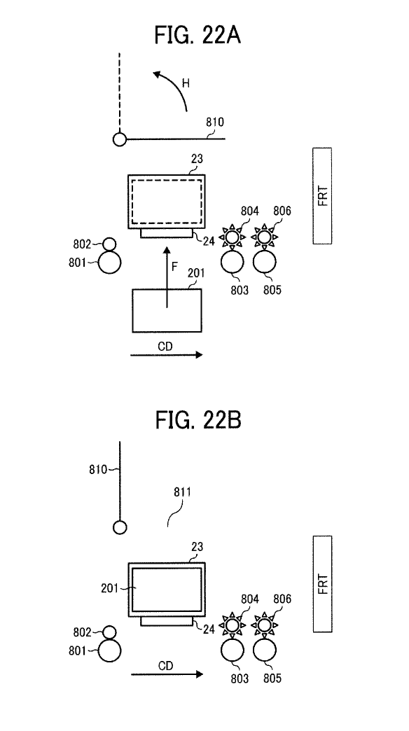

Next, an image forming apparatus according to some exemplary embodiments of this disclosure is described with reference to FIGS. 22A and 22B.

FIGS. 22A and 22B are partial side views of an image forming apparatus according to some exemplary embodiments of this disclosure.

In FIGS. 22A and 22B, recording heads 24 are mounted on a carriage 23 in such a state that the recording heads 24 can eject liquid droplets downward in a vertical direction. A conveyance roller 801 and a driven roller 802 conveys a recording medium so that the recording medium opposes the recording heads 24. A conveyance roller 803 and a spur roller 804 and a conveyance roller 805 and a spur roller 806 feed the recording medium, on which an image has been formed by the recording heads 24, toward a front side FRT of an apparatus body in a conveyance direction CD.

At an upper portion of the apparatus body is disposed an upper cover 810 serving as an opening-and-closing cover to open and close an upper area of the carriage 23. The upper cover 810 is openable and closable between a closed position indicated by a solid line of FIG. 22A and an open position indicated by a broken line of FIG. 22A (i.e., a position of the upper cover 810 in FIG. 22B).

In FIGS. 22A and 22B, a cartridge unit 201 is disposed at a lower side of an apparatus body so as to oppose the carriage 23 via a conveyance path of recording media between the conveyance roller 801 and the conveyance roller 803. The cartridge unit 201 is movable between a supply position indicated by a solid line in FIG. 22A and a replacement position indicated by a broken line in FIG. 22A (i.e., a position of the cartridge unit 201 in FIG. 22B). The cartridge unit 201 does not interfere with a movement range of the carriage 23 and interferes with the movement range of the carriage 23 in moving upward.

As shown in FIGS. 22A and 22B, when the ink cartridges in the cartridge unit 201 are replaced, the upper cover 810 is opened in a direction indicated by an arrow H in FIG. 22A from the open position indicated by the solid line in FIG. 22A to the closed position indicated by the broken line in FIG. 22A (i.e., the position of the upper cover 810 in FIG. 22B). Thus, the carriage 23 is moved to the home position (in a direction toward a rear side of a sheet face on which FIGS. 22A and 22B are printed).

From the supply position on a lower side of the apparatus body, the cartridge unit 201 is moved upward in a direction indicated by an arrow F in FIG. 22A and placed at the replacement position shown in FIG. 22B.

Accordingly, from the upper area of the cartridge unit 201, ink cartridges can be replaced through an opening 811 formed by opening the upper cover 810.

Numerous additional modifications and variations are possible in light of the above teachings. It is therefore to be understood that, within the scope of the appended claims, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. An image forming apparatus, comprising:
a recording head having nozzles to eject droplets of liquid;
a carriage reciprocally movable and mounting a recording head; and
a cartridge unit to replaceably mount a liquid cartridge to store the liquid to be supplied to the recording head, the cartridge unit movable between a supply position at which the cartridge unit does not interfere with a movement range of the carriage and a replacement position at which the cartridge unit interferes with the movement range of the carriage,
wherein, when the carriage is moved, the cartridge unit is moved to the supply position, and
when the liquid cartridge is replaced, the cartridge unit is moved to the replacement position.

2. The image forming apparatus of claim 1, further comprising an apparatus body,
the apparatus body having
an opening, and
a cover to open and close the opening, the liquid cartridge insertable into and extractable from the apparatus body through the opening,
wherein, when the liquid cartridge is replaced, the cartridge unit is moved toward the opening through a position at which the cartridge unit interferes with the movement range of the carriage.

3. The image forming apparatus of claim 2, further comprising a cover sensor to detect opening and closing of the cover.

4. The image forming apparatus of claim 1, wherein a movement direction of the cartridge unit is different from a movement direction of the carriage.

5. The image forming apparatus of claim 1, further comprising:
a conveyance belt disposed opposing the recording head to convey a recording medium;
a media sensor to detect whether or not the recording medium is on the conveyance belt; and
a controller to prohibit movement of the cartridge unit when the media sensor detects the recording medium.

6. The image forming apparatus of claim 1, further comprising a cartridge-unit sensor to detect whether or not the cartridge unit is at the supply position,
wherein, only when the cartridge-unit sensor detects that the cartridge unit is at the supply position, the carriage is moved.

7. The image forming apparatus of claim 1, wherein the recording head is mounted on the carriage in a position in which the droplets of liquid are horizontally ejected from the recording head.
